(19) United States
(12) Patent Application Publication
(10) Pub. No.: US 2026/0005341 A1
(43) Pub. Date: Jan. 1, 2026

(54) BATTERY AND METHOD FOR MANUFACTURING SAME

(71) Applicant: SAMSUNG SDI CO., LTD., Yongin-Si Gyeonggi-do (KR)

(72) Inventor: Jiwon YUN, Yongin-Si (KR)

(21) Appl. No.: 18/941,433

(22) Filed: Nov. 8, 2024

(30) Foreign Application Priority Data
Jun. 27, 2024 (KR) 10-2024-0084651

(51) Int. Cl. H01M 50/109; H01M 50/153; H01M 50/169; H01M 50/181; H01M 50/528; H01M 50/531; H01M 50/609

(52) U.S. Cl. CPC H01M 50/109; H01M 50/153; H01M 50/169; H01M 50/181; H01M 50/528; H01M 50/531; H01M 50/609

(57) ABSTRACT

A battery includes a case including a bottom portion, a sidewall portion connected to the bottom portion, and an upper opening opposite to the bottom portion, an electrode assembly accommodated in the case and including a first electrode tab and a second electrode tab, and a cap assembly configured to seal the upper opening of the case, wherein the bottom portion includes a first region to which the first electrode tab is connected and a second region formed to surround the first region, and wherein an inner surface of the second region includes a recessed portion configured to accommodate an electrolyte.

### CROSS-REFERENCE TO RELATED APPLICATION

The present application claims priority to and the benefit of Korean Application No. 10-2024-0084651, filed on Jun. 27, 2024, in the Korean Intellectual Property Office, the entire disclosure of which is incorporated by reference herein.

### BACKGROUND

### 1. Field

Aspects of embodiments of the present disclosure relate to a battery and a method for manufacturing the battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Along with the trend of miniaturization and thinning of electronic devices in which the secondary batteries are used, there is active research on making secondary batteries more compact and thinner. Increasing the volume of the secondary battery can increase the capacity of the secondary battery, but it has the downside that it is not suitable for small devices. Therefore, there is a significant need for technologies that can increase the capacity of the battery while maintaining or reducing the volume of the battery.

The above information disclosed in this Background section is for enhancement of understanding of the background of the present disclosure, and therefore, it may contain information that does not constitute related (or prior) art.

### SUMMARY

Aspects of embodiments of the present disclosure are directed to a battery and a method for manufacturing the battery that can solve the problems described above.

These and other aspects and features of the present disclosure will be described in or will be apparent from the following description of embodiments of the present disclosure.

According to some embodiments of the present disclosure, there is provided a battery including: a case including a bottom portion, a sidewall portion connected to the bottom portion, and an upper opening opposite to the bottom portion; an electrode assembly accommodated in the case and including a first electrode tab and a second electrode tab; and a cap assembly configured to seal the upper opening of the case, wherein the bottom portion includes a first region to which the first electrode tab is connected and a second region formed to surround the first region, and wherein an inner surface of the second region includes a recessed portion configured to accommodate an electrolyte.

In some embodiments, the second region extends from an outer circumference of the first region by a first length.

In some embodiments, the first length is greater than or equal to a thickness of the first region of the bottom portion.

In some embodiments, the second region extends inward from an outer circumference of the bottom portion by a second length.

In some embodiments, the bottom portion includes a bending portion formed at a portion where the bottom portion is connected to the sidewall portion, and the second length is greater than or equal to a width of the bending portion in a direction of extension of the bottom portion.

In some embodiments, the recessed portion is formed over an entire inner surface of the second region.

In some embodiments, a thickness of the second region in which the recessed portion is formed is less than a thickness of the first region.

In some embodiments, a thickness of the second region in which the recessed portion is formed is greater than or equal to 50% and less than or equal to 75% of a thickness of the first region.

In some embodiments, a thickness of the first region is greater than or equal to 0.12 mm and less than or equal to 0.3 mm.

In some embodiments, a depth of the recessed portion is greater than or equal to 0.03 mm and less than or equal to 0.15 mm.

In some embodiments, a width of the first region corresponds to a width of the first electrode tab.

In some embodiments, the first region includes a welding portion to which the first electrode tab is welded, and a width of the welding portion is 50% or less of a width of the first region.

In some embodiments, the battery is a coin-type battery or a button-type battery.

According to some embodiments of the present disclosure, there is provided a method for manufacturing a battery including: preparing a case including a bottom portion, a sidewall portion connected to the bottom portion, and an upper opening opposite to the bottom portion; preparing an electrode assembly including a first electrode tab and a second electrode tab; inserting the electrode assembly into the case; injecting an electrolyte into the case; and sealing the upper opening by coupling the case with a cap assembly, wherein the bottom portion includes a first region to which the first electrode tab is connected and a second region formed to surround the first region, and wherein an inner surface of the second region includes a recessed portion to accommodate an electrolyte.

In some embodiments, the second region extends from an outer circumference of the first region by a first length.

In some embodiments, the first length is greater than or equal to a thickness of the first region of the bottom portion.

In some embodiments, the second region extends inward from an outer circumference of the bottom portion by a second length.

In some embodiments, the bottom portion includes a bending portion formed at a portion where the bottom portion is connected to the sidewall portion, and the second length is greater than or equal to a width of the bending portion in a direction of extension of the bottom portion.

In some embodiments, a thickness of the second region in which the recessed portion is formed is greater than or equal to 50% and less than or equal to 75% of a thickness of the first region.

In some embodiments, the inserting of the electrode assembly includes: welding the first electrode tab to the first region of the bottom portion; and welding the second electrode tab to the cap assembly

According to some embodiments of the present disclosure, the electrolyte can be introduced into the recessed portion formed in the bottom portion. Thus, the space formed by the recessed portion allows the amount of injecting electrolyte to increase, thereby improving the energy density of the battery.

According to some embodiments of the present disclosure, by arranging the second region having a smaller thickness than that of the first region to surround the first region where the electrode tab is welded, the loss of heat spreading around the welding area during the welding process of the electrode tab can be reduced. Consequently, the welding strength of the electrode tab can be increased.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a longitudinal cross-sectional view illustrating of a battery according to some embodiments of the present disclosure.

FIG. 2 illustrates a first region and a second region formed in a bottom portion of a case according to some embodiments of the present disclosure.

FIG. 3 illustrates a shape of a second region formed in a bottom portion of a case according to some embodiments of the present disclosure.

FIG. 4 illustrates the shape of the second region in the bottom portion of the case, according to some other embodiments of the present disclosure.

FIG. 5 illustrates of a first region and a second region formed in a bottom portion of a case according to some embodiments of the present disclosure.

FIG. 6 illustrates recessed portions at a bottom portion of a case according to some embodiments of the present disclosure.

FIG. 7 illustrates recessed portions at a bottom portion of a case according to some other embodiments of the present disclosure.

FIG. 8 illustrates a recessed portion and a plurality of recessed portions at a bottom portion of a case according to some other embodiment of the present disclosure.

FIG. 9 illustrates an electrode tab being connected to a bottom portion of a case according to still other embodiments of the present disclosure.

FIG. 10 is a flowchart illustrating a method for manufacturing a battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

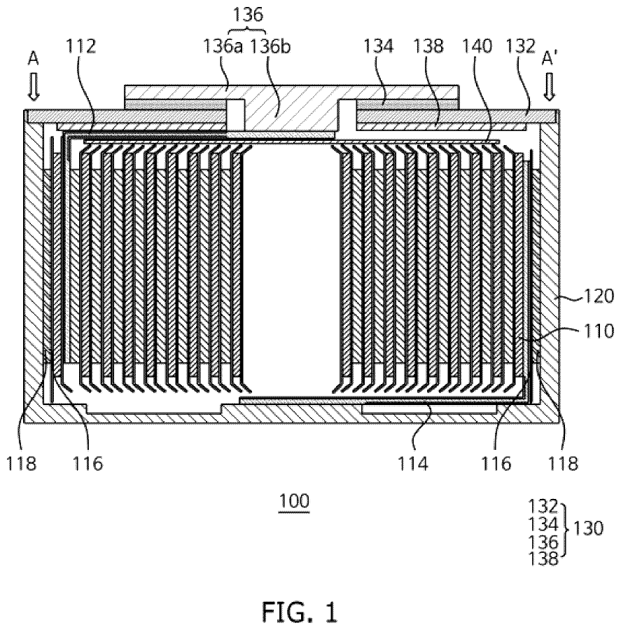

In the present disclosure, the sizes and the relative sizes of regions shown in FIGS. 1 to 10 may be exaggerated for clarity of explanation. That is, the sizes shown in FIGS. 1 to 10 are for the sake of convenience of understanding and are not intended to limit the scope of the present disclosure. Furthermore, throughout the specification, like reference numerals will be used in reference to like parts.

FIG. 1 is a longitudinal cross-sectional view illustrating an example of a battery 100 according to some embodiments of the present disclosure. The battery 100 may include an electrode assembly 110, a case 120, a cap assembly 130, and an insulating washer 140.

The battery 100 may be a coin-type battery or a button-type battery. For example, the battery 100 may have a cylindrical shape. However, the shape of the battery is not limited thereto, and the battery 100 may have a prismatic shape, a pouch shape, a cylindrical shape, or the like. In some examples, the battery 100 is a rechargeable secondary battery that can be charged and discharged.

The electrode assembly 110 may include a first electrode, a second electrode, and a separator. For example, the electrode assembly 110 may be configured by winding the first electrode and the second electrode together with the separator disposed between the first electrode and the second electrode. The electrode assembly 110 may be wound to have a winding core, and the winding core may have a through-hole therein.

The first electrode may include a first substrate and a first active material layer applied onto the first substrate. A first electrode tab 112 may extend outward from a first uncoated portion of the first substrate where the first active material layer is not applied, and the first electrode tab 112 may be electrically connected to a terminal plate 136 of a cap assembly 130.

The second electrode may include a second substrate and a second active material layer applied onto the second substrate. A second electrode tab 114 may extend outward from a second uncoated portion of the second substrate where the second active material layer is not applied, and the second electrode tab 114 may be electrically connected to the case 120. The first electrode tab 112 and the second electrode tab 114 may extend in opposite directions from each other. In some other examples, the first electrode tab 112 and the second electrode tab 114 may extend in the same direction.

In some embodiments, each of the first electrode tab 112 and the second electrode tab 114 may be covered with a cover tape. The cover tape may include an insulating material. The insulating material may provide electrical insulation to prevent current from passing therethrough. The cover tape may prevent a short circuit from occurring at the first electrode tab 112 and the second electrode tab 114 or substantially reduce the likelihood thereof.

The first electrode may serve as a positive electrode. In this example, the first substrate may be composed of, for example, aluminum foil, and the first active material layer may include, for example, a transition metal oxide. The second electrode may serve as a negative electrode. In this example, the second substrate may be composed of, for example, copper foil or nickel foil, and the second active material layer may include, for example, graphite.

The separator may function to prevent or substantially reduce the likelihood of a short circuit between the first electrode and the second electrode while allowing movement of lithium ions. The separator may be composed of, for example, a polyethylene film, a polypropylene film, a polyethylene-polypropylene film, and/or the like, but the scope of the present disclosure is not limited thereto.

Referring to FIG. 1, the first electrode tab 112 of the first electrode may be formed on one side of the electrode assembly 110. The second electrode tab 114 of the second electrode may be formed on the other side of the electrode assembly 110. However, the scope of the present disclosure is not limited thereto. For example, the first electrode tab 112 and the second electrode tab 114 may be formed on one side of the electrode assembly 110.

The battery 100 may include the electrode assembly 110 and an outer housing that accommodates the electrode assembly 110. The outer housing of the battery 100 may include the case 120 and the cap assembly 130 and may constitute an outer shape of the battery 100.

The case 120 may accommodate the electrode assembly 110 and an electrolyte. The case 120 may include a substantially cylindrical sidewall portion and a bottom portion connected to one side of the sidewall portion. However, the case 120 is not limited thereto, and the case 120 may be configured in various shapes such as a circular shape, a pouch shape, or the like. In addition, the case may be composed of metal such as aluminum, an aluminum alloy, or nickel-plated steel, or may be composed of a laminated film or plastic used for a pouch.

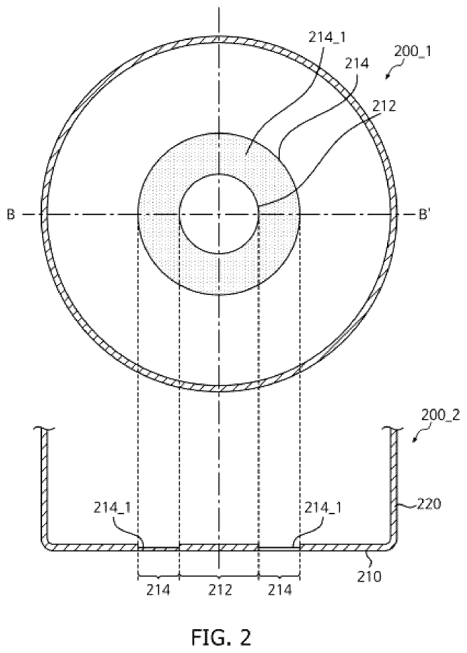

In some embodiments, a bottom portion of the case 120 may be formed with a recessed portion. For example, the bottom portion of the case 120 may include a first region where the electrode tab is welded and a second region surrounding the first region, and the second region may have the recessed portion. The recessed portion in the second region may be deeper relative to the first region, as measured from an inner surface of the bottom portion. Specific examples of the recessed portion formed in the bottom portion of the case 120 will be described in further detail with reference to FIGS. 2 to 9.

The case 120 may be configured to accommodate the electrode assembly 110. The electrode assembly 110 may be inserted into the case 120 through an opening formed at one side of the case 120. The opening of the case 120 may then be closed by the cap assembly 130.

Referring to FIG. 1, the opening of the case 120 may be sealed by the cap assembly 130 by performing welding in welding zones A and A′. The separator of the electrode assembly 110 may be longer in a height direction of the electrode assembly 110 compared to the first electrode and the second electrode. Because a negative electrode substrate 116 is disposed to surround an outer circumferential surface of the electrode assembly 110, one end of the separator of the electrode assembly 110 may be distant from the welding zones A and A′. Similarly, due to the negative electrode substrate 116, the first electrode tab 112 of the electrode assembly 110 may be distant from the welding zones A and A′. As a result, the separator may be positioned not to be pinched between the case 120 and the cap assembly 130 and may not be damaged by the welding performed in the welding zones A and A′. Additionally, the risk of short-circuiting due to damage to the first electrode tab 112 from the welding in the welding zones A and A′ can be prevented or substantially reduced.

The cap assembly 130 may include a cap plate 132, an insulating layer 134, a terminal plate 136, and an insulating member 138. Here, the cap plate 132 may cover the opening of the 120. The cap plate 132 may be coupled to a side surface of the case 120 corresponding to a side surface of the opening.

An insertion hole may be formed at the cap plate 132. For example, the insertion hole may be formed approximately at the center of the cap plate 132. The terminal plate 136 (e.g., an insertion portion 136b of the terminal plate 136) may be inserted into the insertion hole and coupled to the cap plate 132. The terminal plate 136 may include a body portion 136a and the insertion portion 136b protruding from the body portion 136a. Here, the insertion portion 136b of the terminal plate 136 may be inserted into the insertion hole of the cap plate 132. Further, the insertion portion 136b of the terminal plate 136 may be connected to the first electrode tab 112 by contacting the first electrode tab 112. Referring to FIG. 1, the cap assembly 130 including the terminal plate 136 may be coupled to the case 120 such that the insertion portion 136b of the terminal plate 136 faces the electrode assembly.

The insulating layer 134 may be disposed between the terminal plate 136 and the cap plate 132. The insulating layer 134 may have adhesive properties to thereby bond the terminal plate 136 and the cap plate 132. The insulating layer 134 may be formed of an insulating material to electrically insulate the terminal plate 136 and the cap plate 132 from each other.

In some embodiments, the insulating member 138 may be disposed on a bottom surface of the cap plate 132. Here, a top surface of the cap plate 132 may face the body portion 136a of the terminal plate 136, and the bottom surface of the cap plate 132 may face the electrode assembly 110. The insulating member 138 may be formed of an insulating material to provide insulation between the cap plate 132 and the electrode assembly 110 or between the cap plate 132 and the first electrode tab 112.

In some embodiments, the electrode assembly 110 may include the negative electrode substrate 116 surrounding the outer circumferential surface thereof. In this example, the negative electrode substrate 116 may be formed of the same material as the substrate of the second electrode. In some other embodiments, the substrate of the second electrode in the electrode assembly 110 may be extended and wound to wrap around the outer circumferential surface of the electrode assembly. In this example, the substrate of the second electrode may function as the negative electrode substrate.

In some embodiments, the electrode assembly 110 may include a sealing tape 118 that surrounds at least a portion of the outermost circumferential surface of the electrode assembly 110 (i.e., at least a portion of the outer circumferential surface of the negative electrode substrate 116). The sealing tape 118 may serve to secure the wound electrode assembly 110. For example, the winding of the first electrode, the second electrode, and the separator in the electrode assembly 110 can be retained without unwinding by the sealing tape 118. The sealing tape may have adhesive properties, so that the sealing tape is bonded with at least a portion of the outermost circumferential surface of the electrode assembly 110. The sealing tape may include an insulating material. For example, the sealing tape may include polyimides (PI), polyethylene (PE), polystyrene (PS), and/or the like.

In some embodiments, the first electrode tab 112 may be bent under the terminal plate 136 within the case 120 where the electrode assembly 110 is accommodated and the cap assembly 130 is coupled. The bent first electrode tab 112 may be prevented from short-circuiting with the electrode assembly 110 by the insulating washer 140. The insulating washer 140 may be disposed between the electrode assembly 110 and the terminal plate 136. For example, the insulating washer 140 may be disposed between the electrode assembly 110 and the first electrode tab 112 that is located below the terminal plate 136. The insulating washer 140 may include an insulating material. By disposing the insulating washer 140, the first electrode tab 112 may be spaced apart from the electrode assembly 110. Further, the insulating washer 140 may provide electrical insulation between the first electrode tab 112 and the electrode assembly 110.

FIG. 2 illustrates a first region 212 and a second region 214 formed in a bottom portion 210 of a case according to some embodiments of the present disclosure. A first plan view 200_1 is a plan view showing the bottom portion 210 of the case while a first side view 200_2 is a longitudinal cross-sectional view of the case taken along a line B-B′ of the first plan view 200_1.

Referring to the first plan view 200_1 and the first side view 200_2, the case may include the bottom portion 210 and a sidewall portion 220 extending in a substantially vertical direction along a circumference of the bottom portion 210. The bottom portion 210 may include the first region 212 that is formed for welding an electrode tab and the second region 214 that is formed to surround the first region 212.

In some embodiments, a recessed portion 214_1 may be formed in the second region 214 recessed from an inner surface of the bottom portion 210 facing the electrode assembly. For example, the second region 214 may include a recessed portion 214_1 that is more deeply recessed from the inner surface of the bottom portion 210, as compared to the first region 212.

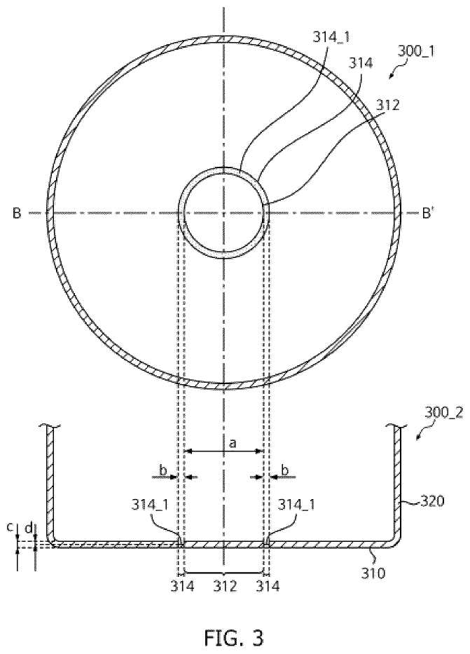

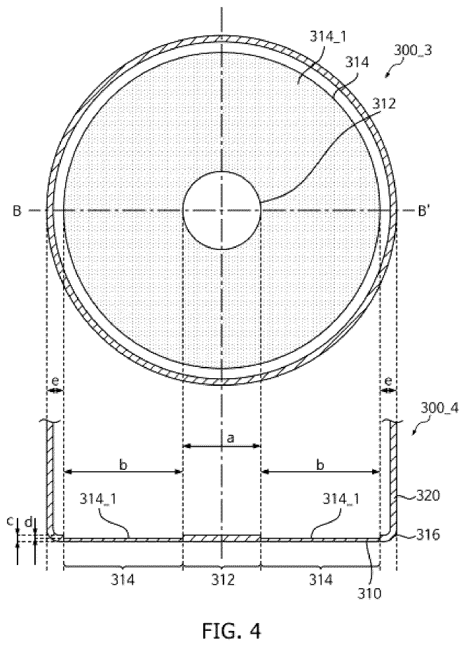

In some embodiments, a thickness of the second region 214 where the recessed portion 214_1 is formed may be less than a thickness of the first region 212. For example, an outer surface of the bottom portion 210 may be formed uniformly flat without differentiation between the first region 212 and the second region 214, while the inner surface of the bottom portion 210 may be formed with surface irregularities caused by the recessed portion 214_1. Consequently, the thickness of the second region 214 with the recessed portion 214_1 may be reduced compared to the thickness of the first region 212 by an amount corresponding to a depth of the recessed portion 214_1. The depth of the recessed portion 214_1 may be adjusted appropriately based on factors such as the area and shape of the recessed portion 214_1, while maintaining the desired rigidity of the case. Examples of the shape and depth of the recessed portion 214_1 will be described in more detail with reference to FIGS. 3 and 4.

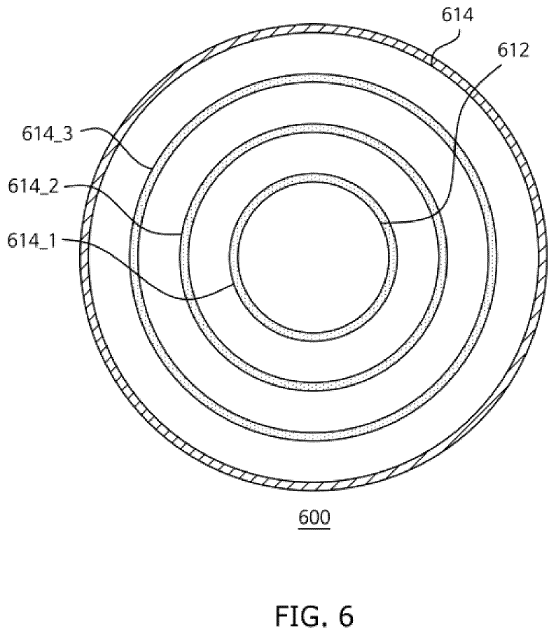

While FIG. 2 illustrates the recessed portion 214_1 as being formed over the entire second region 214 with respect to the inner surface of the bottom portion 210, the present disclosure is not limited thereto. For example, the recessed portion 214_1 may alternatively be formed in only a portion of the second region 214 with respect to the inner surface of the bottom portion 210. Examples in which the recessed portion 214_1 is formed in the portion of the second region 214 will be described in more detail with reference to FIGS. 6 to 8.

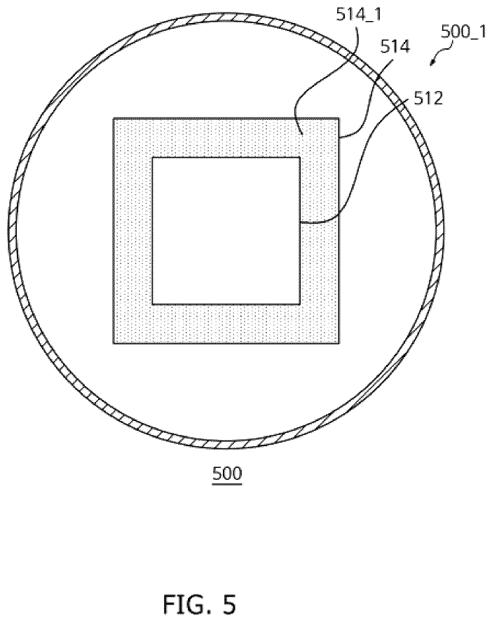

Further, while FIG. 2 illustrates the first region 212, where the electrode tab is welded, as being formed in a substantially circular shape at the center of the bottom portion 210, the present disclosure is not limited thereto. Examples of various shapes for the first region 212 will be described in more detail with reference to FIG. 5.

With this configuration, during the process of injecting the electrolyte after inserting the electrode assembly into the case, the electrolyte can also be introduced into the recessed portion 214_1 formed in the bottom portion 210. The space formed by the recessed portion 214_1 may allow the amount of injecting electrolyte to increase. Therefore, the energy density of the battery can be improved.

Further, by arranging the second region 214 having a smaller thickness than that of the first region 212 to surround the first region 212 where the electrode tab is welded, the loss of heat spreading around the welding area during the welding process of the electrode tab can be reduced. Consequently, the welding strength of the electrode tab can be increased.

FIG. 3 illustrates a shape of a second region 314 formed in a bottom portion 310 of a case according to some embodiments of the present disclosure. FIG. 4 illustrates of the shape of the second region 314 in the bottom portion 310 of the case according to some other embodiments of the present disclosure.

Referring to FIG. 3, a second plan view 300_1 is a plan view showing the bottom portion 310 of the case while a second side view 300_2 is a longitudinal cross-sectional view of the case taken along a line B-B′ of the second plan view 300_1.

Referring to the second plan view 300_1 and the second side view 300_2, the bottom portion 310 may include a first region 312 that is formed for welding an electrode tab and the second region 314 that is formed to surround the first region 312. The second region 314 may include a recessed portion 314_1 that is more deeply recessed from the inner surface of the bottom portion 310 facing the electrode assembly, as compared to the first region 312. For example, a width ‘a’ of the first region 312 may correspond to a width in a direction horizontally perpendicular to a direction in which the electrode tab extends, but the present disclosure is not limited thereto.

In some embodiments, the second region 314 may include a region extending from an outer circumference of the first region 312 by a first length ‘b.’ That is, the first length ‘b’ by which the second region 314 extends from the outer circumference of the first region 312 may determine a lower limit of the region to which the second region 314 extends. Here, the first length ‘b’ may be greater than or equal to a thickness ‘c’ of the first region 312, but the present disclosure is not limited thereto. For example, the thickness ‘c’ of the first region 312 may be greater than or equal to 0.12 mm and less than or equal to 0.3 mm, but the present disclosure is not limited thereto.

In some embodiments, a depth ‘d’ of the recessed portion 314_1 may be adjusted appropriately based on factors such as the area and shape of the recessed portion 314_1, while maintaining the desired rigidity of the case. For example, a thickness of the second region 314 where the recessed portion 314_1 is formed may be greater than or equal to 50% and less than or equal to 75% of the thickness of the first region 312, but the present disclosure is not limited thereto. For example, the depth of the recessed portion 314_1 may be greater than or equal to 0.03 mm and less than or equal to 0.15 mm, but the present disclosure is not limited thereto.

Referring to FIG. 4, a third plan view 300_3 is a plan view showing the bottom portion 310 of the case while a third side view 300_4 is a longitudinal cross-sectional view of the case taken along a line B-B′ of the third plan view 300_3.

Referring to the third plan view 300_3 and the third side view 300_4, a sidewall portion 320 of the case may extend in a direction approximately and vertically perpendicular to the bottom portion 310 of the case. The bottom portion 310 may have a bending portion 316 formed at a portion where the bottom portion 310 is connected to the sidewall portion 320. For example, the bending portion 316 may be formed by rolling the bottom portion 310 to have a predetermined curvature at the portion where the bottom portion 310 is connected to the sidewall portion 320 during the manufacturing process of the case.

In some embodiments, the second region 314 may extend inward from an outer circumference of the bottom portion 310 by a second length ‘e.’ That is, the second length ‘e’ by which the second region 314 extends from the outer circumference of the bottom portion 310 may determine an upper limit of a region to which the second region 314 extends. Here, the second length ‘e’ may be greater than or equal to a width of the bending portion 316 in a direction of extension of the bottom portion 310. Accordingly, the case may be designed so that the second region 314 is not formed in the bending portion 316, which may reduce the rigidity of the case as the case is bent to form the bottom portion 310 and the sidewall portion 320.

Thus, the second region 314 may be formed with any suitable variation between the lower limit of the second region 314 illustrated in FIG. 3 and the upper limit of the second region 314 illustrated in FIG. 4. With this configuration, the second region 314 can formed in an improved (e.g., optimized) shape so as to provide sufficient welding strength between the electrode tab and the case while maintaining the structural rigidity of the case as an external component.

FIG. 5 illustrates a first region 512 and a second region 514 formed in a bottom portion 500 of a case according to some embodiments of the present disclosure. In some embodiments, the bottom portion 500 of the case may include the first region 512 that is formed for welding an electrode tab, and a second region 514 that is formed to surround the first region 512. The second region 514 may have a recessed portion 514_1 that is more deeply recessed from an inner surface of the bottom portion 500, as compared to the first region 512.

In some embodiments, the second region 514 may include a region extending from an outer circumference of the first region 512 by a first length. Here, the first length may be greater than or equal to a thickness of the bottom portion 500 in the first region 512, but the present disclosure is not limited thereto. Further, the thickness of the bottom portion 500 in the first region 512 may be greater than or equal to 0.12 mm and less than or equal to 0.3 mm, but the present disclosure is not limited thereto.

Additionally, the second region 514 may extend inward from an outer circumference of the bottom portion 500 by a second length. The bottom portion 500 may have a bending portion formed at a portion where the bottom portion 500 is connected a sidewall portion, and the second length may be greater than or equal to a width of the bending portion in a direction of extension of the bottom portion.

As shown in FIG. 5, the first region 512 may have a polygonal shape, and the shape of the second region 514 may be determined based on the shape of the first region 512. For example, the shape of the first region 512 may be approximately square. The second region 514 may be formed in an approximately square shape that extends from the outer circumference of the first region 512 by a predetermined length, but the present disclosure is not limited thereto. For example, the second region 514 may be suitably altered to include the region extending from the outer circumference of the first region 512 by the first length and not extending beyond a position spaced inward from the outer circumference of the bottom portion 500 by the second length.

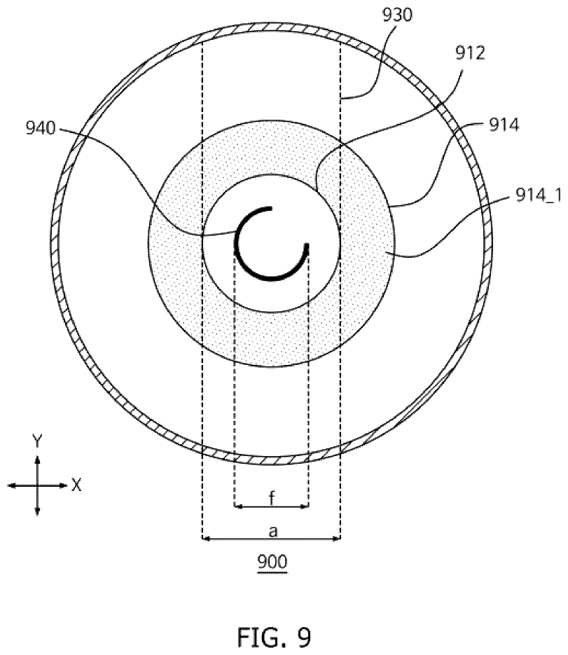

In FIG. 5, the first region 512 is illustrated as having a square shape, but the shape of the first region 512 is not limited thereto. The shape of the first region 512 may be appropriately modified such that a width of the first region 512 corresponds to a width of the electrode tab. The positional relationship and the size relationship between the electrode tab and the first region 512 will be described in further detail with reference to FIG. 9.

FIG. 6 illustrates recessed portions 614_1 to 614_3 at a bottom portion of a case according to some embodiments of the present disclosure. In some embodiments, the bottom portion 600 of the case may include a first region 612 that is formed for welding an electrode tab, and a second region 614 that is formed to surround the first region 612. The second region 614 may include the recessed portions 614_1 to 614_3 that are more deeply recessed from an inner surface of the bottom portion 600, as compared to the first region 612.

Referring to FIG. 6, the second region 614 may include a plurality of recessed portions 614_1 to 614_3. For example, the second region 614 may include a plurality of annular recessed portions 614_1 to 614_3 (e.g., first to third recessed portions), which are concentrically arranged. In this configuration, the first recessed portion 614_1 may be formed to reduce the loss of heat spreading around a welding area during a welding process of the electrode tab. Further, the second recessed portion 614_2 and the third recessed portion 614_3 may be additionally formed in the second region 614, so that the amount of electrolyte contained within the case can be further increased.

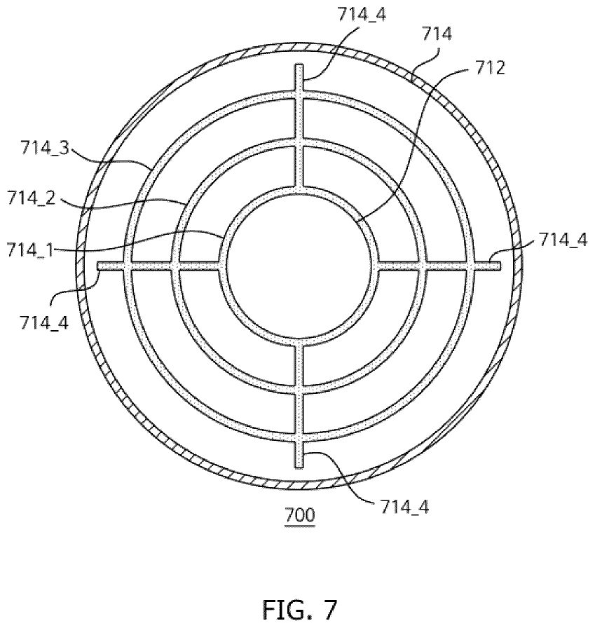

FIG. 7 illustrates recessed portions 714_1 to 714_4 at a bottom portion of a case according to some embodiments of the present disclosure. In some embodiments, the bottom portion 700 of the case may include a first region 712 that is formed for welding an electrode tab, and a second region 714 that is formed to surround the first region 712. The second region 714 may include the recessed portions 714_1 to 714_4 that are more deeply recessed from an inner surface of the bottom portion 700, as compared to the first region 712.

Referring to FIG. 7, the second region 714 may have a plurality of annular recessed portions 714_1 to 714_3, which are concentrically arranged, and a linear recessed portion 714_4 connecting the annular recessed portions 714_1 to 714_3. Accordingly, as compared to the example shown in FIG. 6, the space formed by the linear recessed portion 714_4 may allow an additional amount of electrolyte to be contained within the case.

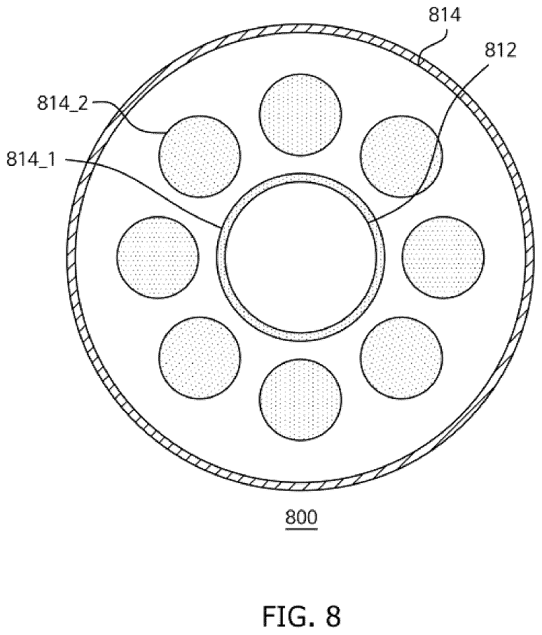

FIG. 8 illustrates a recessed portion 814_1 and a plurality of recessed portions 814_2 at a bottom portion of a case according to some embodiments of the present disclosure. In some embodiments, the bottom portion 800 of the case may include a first region 812 that is formed for welding an electrode tab, and a second region 814 that is formed to surround the first region 812. The second region 814 may include the recessed portion 814_1 and the plurality of recessed portions 814_2 that are more deeply recessed from an inner surface of the bottom portion 800, as compared to the first region 812.

Referring to FIG. 8, the second region 814 may include the recessed portion (first recessed portion) 814_1 and the plurality of recessed portions (second recessed portions) 814_2. For example, the first recessed portion 814_1 surrounding the first region 812 may be formed to reduce the loss of heat spreading around a welding area during a welding process of the electrode tab. Further, as shown in FIG. 8, the plurality of second recessed portions 814_2 may be arranged spaced apart from each other.

The recessed portion(s) formed in the second region may have various shapes, and the shape of the recessed portion(s) is not limited those of the embodiments described in FIGS. 6 to 8. The recessed portion(s) is formed in the second region, and the number, shape, and arrangement of the recessed portions may be varied as appropriate.

FIG. 9 illustrates an electrode tab 930 being connected to a bottom portion 900 of a case according to some embodiments of the present disclosure. In some embodiments, the bottom portion 900 of the case may include a first region 912 and a second region 914 formed to surround the first region 912. The second region 914 may include a recessed portion 914_1 that is more deeply recessed from an inner surface of the bottom portion 900, as compared to the first region 912.

The electrode tab 930 may be welded to the first region 912. For example, the electrode tab 930 may protrude from the electrode assembly and extend to be connected with the first region 912 of the bottom portion 900. For convenience of explanation, it is assumed that the electrode tab 930 extends in a direction parallel to a first direction (e.g., the Y-axis) and is disposed on the first region 912.

In some embodiments, the electrode tab 930 may be disposed on the first region 912 such that the electrode tab 930 does not protrude beyond the first region 912 in a second direction (e.g., the X-axis). In this example, a width ‘a’ of the first region 912 may correspond to, but is not limited to, a width of the electrode tab 930 in the second direction (e.g., the X-axis).

In some embodiments, the first region 912 may include a welding portion 940 where the electrode tab 930 is welded. In this example, the maximum width ‘f’ of the welding portion 940 may be 50% or less of the width of the electrode tab 930 in the second direction (e.g., the X-axis). Accordingly, the maximum width ‘f’ of the welding portion 940 may be 50% or less of the width ‘a’ of the first region 912.

In FIG. 9, a shape of the welding portion 940 is shown to be approximately a C-shape, but the present disclosure is not limited thereto. For example, the welding portion 940 may be formed in a shape of a straight line or a plurality of points spaced apart by a certain distance. In such cases as well, the maximum width ‘f’ of the welding portion 940 may be 50% or less of the width of the electrode tab 930 in the second direction (e.g., the X-axis). Accordingly, the maximum width ‘f’ of the welding portion 940 may be 50% or less of the width ‘a’ of the first region 912.

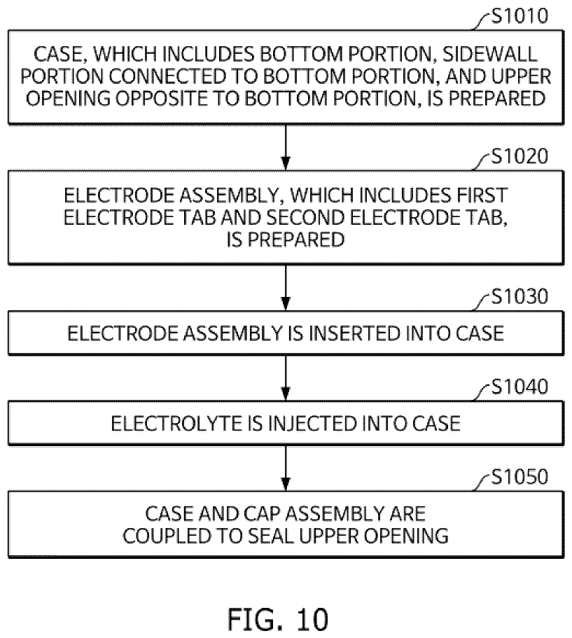

FIG. 10 is a flowchart illustrating a method 1000 for manufacturing a battery according to some embodiments of the present disclosure. The method 1000 may begin with preparing a case that includes a bottom portion, a sidewall portion connected to the bottom portion, and an upper opening opposite to the bottom portion (S1010). Further, the method may further include preparing an electrode assembly that is accommodated in the case and includes a first electrode tab and a second electrode tab (S1020).

In some embodiments, the bottom portion may include a first region to which the first electrode tab is connected and a second region formed to surround the first region. Further, the bottom portion may include a bending portion formed at a portion where the bottom portion is connected to the sidewall portion.

In some embodiments, the second region may include a region extending from an outer circumference of the first region by a first length. In this example, the first length may be greater than or equal to a thickness of the first region of the bottom portion. Further, the second region may extend inward from an outer circumference of the bottom portion by a second length. In this example, the second length may be greater than or equal to a width of the bending portion in a direction of extension of the bottom portion.

Next, the electrode assembly may be inserted into the case (S1030). During the process of inserting the electrode assembly into the case, the first electrode tab of the electrode assembly may be welded to the first region of the bottom portion, and the second electrode tab of the electrode assembly may be welded to the cap assembly.

Next, the electrolyte may be injected into the case (S1040). The second region of the bottom portion of the case may have a recessed portion, and the electrolyte may be received in the recessed portion during the process of injecting the electrolyte into the case. In some embodiments, a thickness of the recessed portion may be greater than or equal to 50% and less than or equal to 75% of a thickness of the first region, but the present disclosure is not limited thereto. Thereafter, the case and the cap assembly may be coupled to seal the opening of the case (S1050).

The flowchart and the description of FIG. 10 are merely examples of the present disclosure, but the scope of the present disclosure is not limited to the flowchart and the above description of FIG. 10. For example, one or more of the processes in the flowchart and the above description may be added, altered, and/or deleted, the sequence of one or more of the steps may be changed, and one or more of the processes may be performed concurrently (e.g., simultaneously).

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

100: battery
110: electrode assembly
112: first electrode tab
114: second electrode tab
116: negative electrode substrate
118: sealing tape
120: case
130: cap assembly
132: cap plate
134: insulating layer
136: terminal plate
136a: body portion
136b: insertion portion
138: insulating member
140: insulating washer

What is claimed is:

1. A battery comprising:
a case comprising a bottom portion, a sidewall portion connected to the bottom portion, and an upper opening opposite to the bottom portion;
an electrode assembly accommodated in the case and comprising a first electrode tab and a second electrode tab; and
a cap assembly configured to seal the upper opening of the case,
wherein the bottom portion comprises a first region to which the first electrode tab is connected and a second region formed to surround the first region, and
wherein an inner surface of the second region comprises a recessed portion configured to accommodate an electrolyte.

2. The battery as claimed in claim 1, wherein the second region extends from an outer circumference of the first region by a first length.

3. The battery as claimed in claim 2, wherein the first length is greater than or equal to a thickness of the first region of the bottom portion.

4. The battery as claimed in claim 1, wherein the second region extends inward from an outer circumference of the bottom portion by a second length.

5. The battery as claimed in claim 4, wherein the bottom portion comprises a bending portion formed at a portion where the bottom portion is connected to the sidewall portion, and
wherein the second length is greater than or equal to a width of the bending portion in a direction of extension of the bottom portion.

6. The battery as claimed in claim 1, wherein the recessed portion is formed over an entire inner surface of the second region.

7. The battery as claimed in claim 1, wherein a thickness of the second region in which the recessed portion is formed is less than a thickness of the first region.

8. The battery as claimed in claim 1, wherein a thickness of the second region in which the recessed portion is formed is greater than or equal to 50% and less than or equal to 75% of a thickness of the first region.

9. The battery as claimed in claim 1, wherein a thickness of the first region is greater than or equal to 0.12 mm and less than or equal to 0.3 mm.

10. The battery as claimed in claim 1, wherein a depth of the recessed portion is greater than or equal to 0.03 mm and less than or equal to 0.15 mm.

11. The battery as claimed in claim 1, wherein a width of the first region corresponds to a width of the first electrode tab.

12. The battery as claimed in claim 1, wherein the first region comprises a welding portion to which the first electrode tab is welded, and
wherein a width of the welding portion is 50% or less of a width of the first region.

13. The battery as claimed in claim 1, wherein the battery is a coin-type battery or a button-type battery.

14. A method for manufacturing a battery comprising:
preparing a case comprising a bottom portion, a sidewall portion connected to the bottom portion, and an upper opening opposite to the bottom portion;
preparing an electrode assembly comprising a first electrode tab and a second electrode tab;
inserting the electrode assembly into the case;
injecting an electrolyte into the case; and
sealing the upper opening by coupling the case with a cap assembly,
wherein the bottom portion comprises a first region to which the first electrode tab is connected and a second region formed to surround the first region, and
wherein an inner surface of the second region comprises a recessed portion to accommodate an electrolyte.

15. The method as claimed in claim 14, wherein the second region extends from an outer circumference of the first region by a first length.

16. The method as claimed in claim 15, wherein the first length is greater than or equal to a thickness of the first region of the bottom portion.

17. The method as claimed in claim 14, wherein the second region extends inward from an outer circumference of the bottom portion by a second length.

18. The method as claimed in claim 17, wherein the bottom portion comprises a bending portion formed at a portion where the bottom portion is connected to the sidewall portion, and
wherein the second length is greater than or equal to a width of the bending portion in a direction of extension of the bottom portion.

19. The method as claimed in claim 14, wherein a thickness of the second region in which the recessed portion is formed is greater than or equal to 50% and less than or equal to 75% of a thickness of the first region.

20. The method as claimed in claim 14, wherein the inserting of the electrode assembly comprises:
welding the first electrode tab to the first region of the bottom portion; and
welding the second electrode tab to the cap assembly.
